(19) United States
(12) Patent Application Publication
(10) Pub. No.: US 2015/0013111 A1
(43) Pub. Date: Jan. 15, 2015

(54) RIGID FIXTURE FOR COUPLING ONE OR MORE TRANSDUCERS TO THE UPPER BACK OF THE HUMAN BODY

(71) Applicant: Michael Joseph White, Brooklyn, NY (US)

(72) Inventor: Michael Joseph White, Brooklyn, NY (US)

(21) Appl. No.: 13/934,909

(22) Filed: Jul. 3, 2013

(51) Int. Cl. A45F 5/00; G08B 6/00

(52) U.S. Cl. CPC A45F 5/00; G08B 6/00; A45F 2200/05
USPC 24/3.1

(57) ABSTRACT

One embodiment of a rigid fixture for coupling one or more transducers to the center upper back of the human body. The left contact area (10) and right contact area (11) are curved surfaces designed to ergonomically fit against the trapezius muscle groups. The contact areas (10) and (11) may optionally be covered with a cushioning pads (31). Between the contact areas (10) and (11) is a center section spaced away from the spine (12) that is not in contact with the human body. One or more transducers (30) are attached or incorporated into the center section (12), which may be facilitated by transducer attach points (21). The entire fixture can be fastened to straps, belts, harnesses, backpacks, clothing, or seats by the attach points (20).

### CROSS-REFERENCE TO RELATED APPLICATIONS

This application claims the benefit of the provisional patent Application No. 61/668,370 filed Jul. 5, 2012 by the present inventor.

### BACKGROUND

### Prior Art

The following is a tabulation of some prior art that presently appears relevant:

U.S. Patents

| Patent Nr. | Kind | Filing Date | Inventor | Title |
|---|---|---|---|---|
| 7967679 | B2 | Dec. 7, 2007 | Mark P. Ombrellaro, | Tactile wearable gaming |
| | | | Baltazar Soto, Jr., Aaron | device |
| | | | Leonard Morris, Joshua | |
| | | | John Kelly, Patrick A. | |
| | | | Ombrellaro | |
| 8139803 | B2 | May 12, 2006 | Shahriar S. Afshar | Systems and methods for |
| | | | | haptic sound |
| 7440581 | B2 | Apr. 24, 2006 | David Wiener | Backpack with integrated |
| | | | | speakers |
| 7331871 | B2 | May 5, 2004 | Miguel Lopez | Tactile signal-producing |
| | | | | vest worn while playing a |
| | | | | video game |
| 6275213 | B1 | May 1, 2000 | Mark R. Tremblay, Mark | Tactile feedback man- |
| | | | H. Yim | machine interface device |
| D411576 | S | Jun. 29, 1998 | Edward L. Hames | Vest for use with a video |
| | | | | game system |
| 5687244 | A | Mar. 28, 1996 | Peter Untersander | Bone conduction speaker |
| | | | | and mounting system |
| 6004209 | A | May 29, 1995 | Keiji Fujimoto, Akira | Body-acoustic device, |
| | | | Fujiwara, Tokurou | playing apparatus and its |
| | | | Fujiwara, Atsushi | control method, light-beam |
| | | | Katsumoto, Masahiko | utilizing playing apparatus, |
| | | | Kurokawa, Koji Miura, | and acoustic apparatus |
| | | | Kazuyuki Seri, Nobuo | |
| | | | Takenouchi | |
| 5680465 | A | Apr. 5,1995 | James H. Boyden | Headband audio system |
| | | | | with acoustically |
| | | | | transparent material |
| 5669818 | A | Mar. 23, 1995 | Thomas K. Glass, Craig | Seat-based tactile sensation |
| | | | Thorner | generator |
| 5565840 | A | Sep. 21, 1994 | Thomas K. Glass, Craig | Tactile sensation generator |
| | | | Thorner | |
| 5553148 | A | Jun. 20, 1994 | Ben Werle | Apparatus and method for |
| | | | | producing vibratory |
| | | | | sensations to accompany |
| | | | | audible sounds in a |
| | | | | properly phased |
| | | | | relationship |
| D355751 | S | Jan. 6, 1994 | Gideon Dagan | Video game accessory vest |
| 4641345 | A | Dec. 28, 1984 | Yoshio Takahashi | Body-sensible acoustic |
| | | | | device |
| 4485276 | A | Aug. 3, 1983 | Masaaki Sato | Personal audio device |
| 4322585 | A | May 5, 1980 | James P. Liautaud | Personal electronic |
| | | | | listening system with an air |
| | | | | and bone transducer |
| | | | | mounted on the clothing |
| | | | | collar |
| 4070553 | A | Feb. 10, 1977 | William J. Hass | Personal audio listening |
| | | | | system |

U.S. Patent Application Publications

| | | Filing | | |
|---|---|---|---|---|
| Publ. Nr. | Kind | Date | Applicant | Title |
| EP 0746393 | A1 | Sep. 14, | Lawrence Shultz, | Dual output multi |
| | | 1994 | David Tung, | function interface device |
| | | | Richard Vincent | for audio systems |
| EP 0009116 | A1 | Aug. 13, | Rene Dr. | Device and method for |
| | | 1979 | Pomeranz | the electroacoustic re- |
| | | | | production of sound by |
| | | | | earphones, as well as a |
| | | | | device for transmitting |
| | | | | sound vibrations |
| | | | | to the human body |

Many naturally occurring sounds are often very loud and of a low frequency, thunder claps being an example. Such sounds are often felt in the whole human body as much as they are heard. This visceral feeling is just as an important a component of the experience as is the actual heard sound. Further, large PA systems and large sound systems, at night clubs and at concert venues, often feature music or other content with loud and low frequency sounds. Again, much of this content is felt by the human body just as much as it is heard. However, most small sound reproduction systems that are portable or carry-able by a single person cannot create an experience that can be felt in the body—its just too impractical to incorporate large high powered speakers into such devices.

A solution to this problem is the use of tactile transducers instead of large speakers. The tactile transducer does not create sound but rather creates vibration that is transmitted directly to the listener—either by being mounted to furniture—or by being mounted directly to the human body in some fashion. Thus small portable audio devices can recreate this desired visceral overall body experience in a small portable package.

Several devices for coupling transducers to the human body have been proposed—yet all mounting methods heretofore known suffer from a number of disadvantages:

(a) They mount the transducer to the front of the human body, often the chest. This makes it difficult for the device to fit varying body types and and body types of differing genders. These designs are not unisex. (U.S. Pat. Nos. 8,139,803, 5,687,244, D355751, 4,070,553. Also EP 0009116)

(b) They are mounted directly on bones or areas of the body with significant cartilage such as the spine or sternum (U.S. Pat. Nos. 6,275,213, 5,687,244, 4,070,553). Vibration related health concerns are most severe when vibration is applied to bone and cartilage areas of the body and should be avoided.

(c) They do not allow for adequate airflow to cool transducers—often placing transducers inside of fabric pockets or fully enclosing them in enclosures with little or no airflow or venting. (U.S. Pat. Nos. 8,139,803, 7,440,581, 7,331,871, 6,275,213, 5,687,244, 6,004,209)

(d) When mounted on the human back, they are mounted on the lower back. This interferes with sitting in any chair while wearing the device. (U.S. Pat. Nos. 6,004,209, D355751)

(e) They place transducers directly against the human body. Since most transducers are not ergonomically shaped—this is uncomfortable for the wearer. (U.S. Pat. Nos. 7,440,581, 7,331,871, 6,275,213)

(f) They do not have mounting points for harnesses on the transducers—thus having to place transducers in pockets of a harness or garment. Since transducers shake when creating vibration, any slack in the pockets or harness is undesirable. Further some designs do not use harnesses at all, using gravity to hold the transducer to the human body. Unless the transducer is firmly attached to the human body, much of the vibration is wasted as inefficient shaking (U.S. Pat. Nos. 7,440,581, 7,331,871, 4,322,585, 4,070,553)

(g) They must use multiple transducers to transmit vibration symmetrically to more than one place on the human body. (U.S. Pat. Nos. 7,967,679, 8,139,803, 7,440,581, 7,331,871, 6,275,213)

### SUMMARY

In accordance with one embodiment comprises a rigid fixture for coupling one or more tactile transducers to the upper back of the human body on or near the trapezius muscle groups. The fixture may be made of plastic, metal, composites, wood, or other rigid material and may optionally include cushioning pads where contacting the body made of silicone, foam, or other material. The fixture is ergonomically designed to be centered on the upper back where the left and right side are in direct contact with the body, and the center of the structure is spaced away from the spinal area of the body. One or more tactile transducers are mounted in this center section.

### Advantages

Accordingly several advantages of one or more aspects are as follows: to allow the fixture to be ergonomically and comfortably fit to a wide variety of body types regardless of gender (the design is unisex) and regardless of the specific transducer used, to transmit the transducer created vibration symmetrically to the trapezius muscle groups but not to the spine directly even when one transducer is used, to allow the transducer to have full ventilation to dissipate heat, to serve as an attachment surface for harnesses, clothing, or backpacks to which the device is incorporated, to allow comfortable sitting on low back chairs when worn with a harness, and to serve as a body contact point when built into seats or other fixed objects.

### DRAWINGS

### Figures

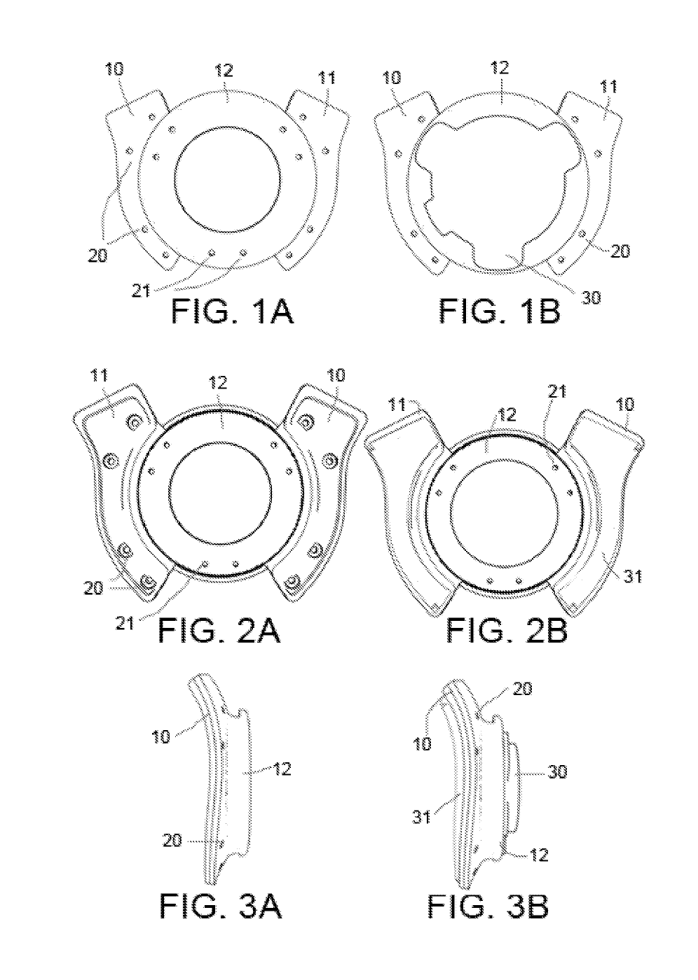

FIG. 1A shows various aspects of a rigid fixture from a top view—the area facing away from the human body.

FIG. 1B shows the same fixture as FIG. 1A but also includes the outline of an attached transducer.

FIG. 2A shows the same rigid fixture from a bottom view—the area facing toward the human body.

FIG. 2B shows the same fixture as FIG. 2A but also includes an attached transducer and optional cushioning pads.

FIG. 3A shows the same rigid fixture from a side view.

FIG. 3B shows the same fixture as FIG. 3A but also includes an attached transducer and optional cushioning pads.

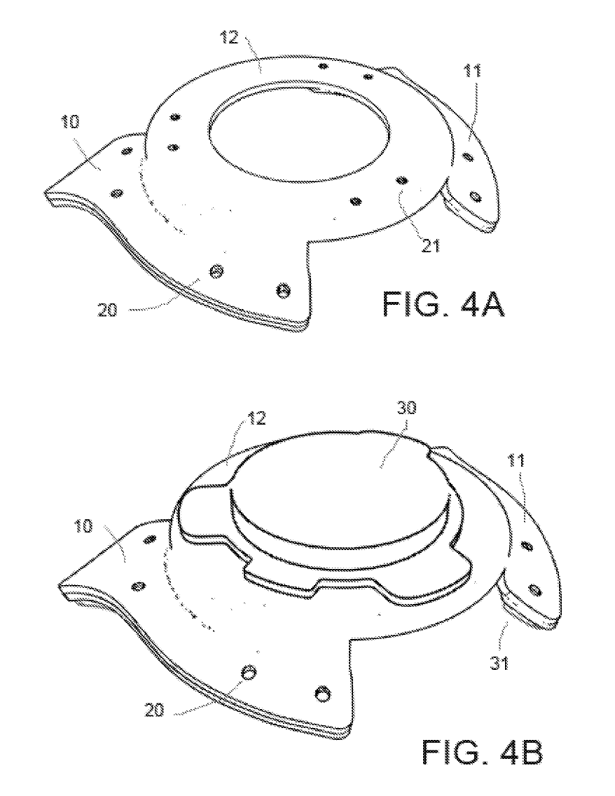

FIG. 4A shows the same rigid fixture from a top perspective view.

FIG. 4B show the same fixture as FIG. 4A but with an attached transducer and optional cushioning pads.

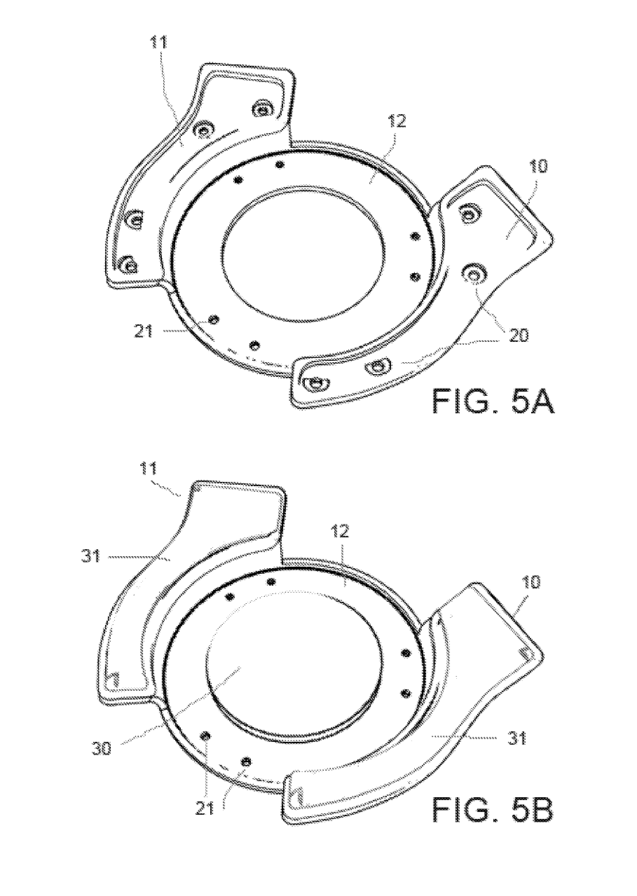

FIG. 5A shows the same rigid fixture from a bottom perspective view.

FIG. 5B shows the same fixture as FIG. 5A but also includes an attached transducer and optional cushioning pads.

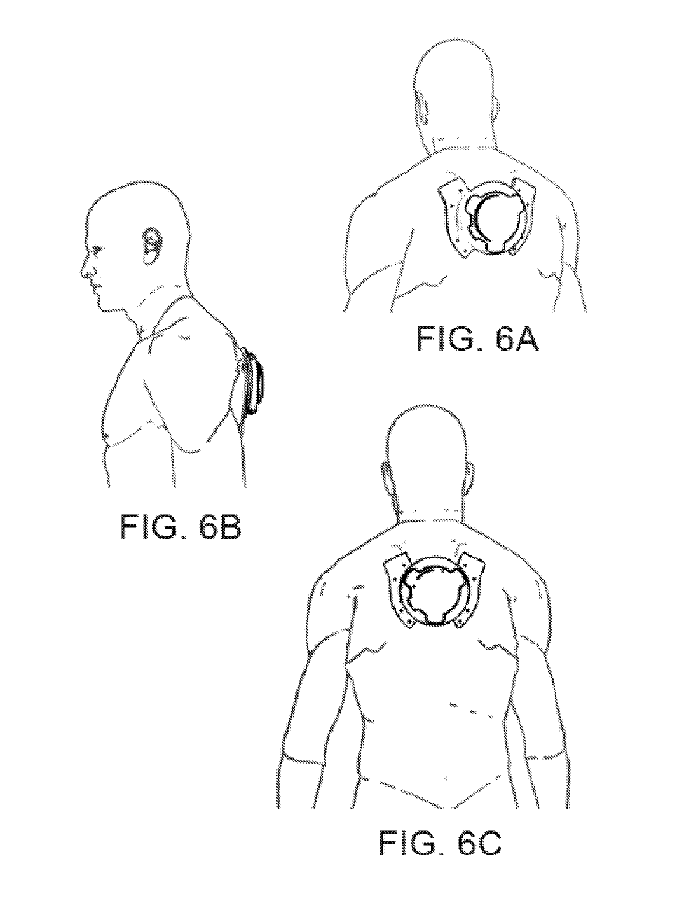

FIGS. 6A, 6B, and 6C show where the fixture is placed on the human body.

Drawings-Reference Numerals

| | |
|---|---|
| 10 | left side contact area |
| 11 | right side contact area |
| 12 | center section spaced away from the |
| | spine |
| 20 | attach points for harness, clothing, |
| | backpacks, or mounting in seating |
| | or other fixed objects |
| 21 | attach points to mount one or more |
| | transducers |
| 30 | a tactile transducer |
| 31 | cushioning pad |

### DETAILED DESCRIPTION

### FIGS. 1A, 1B, 2A, 2B, 3A, 3B, 6A, 6B, 6C

One embodiment of the fixture is illustrated in FIG. 1A (top view), FIG. 2A (bottom view), and FIG. 3A (side view). The fixture may be made of plastic, metal, composites, wood, or other rigid material. The fixture is centered on the upper back of the human body (FIGS. 6A-6C). The left contact area 10 and right contact area 11 are curved surfaces designed to ergonomically fit against the trapezius muscle groups. The contact areas 10 and 11 may optionally be covered with a cushioning pads 31 made of silicone, foam, gel, or other material. Between the contact areas 10 and 11 is a center section spaced away from the spine 12 that is not in contact with the body. One or more transducers 30 are attached or incorporated into the center section 12, which may be facilitated by transducer attach points 21. The entire fixture can be fastened to straps, belts, harnesses, backpacks, clothing, or seats by the attach points 20.

### Operation—FIGS. 1B, 2B, 3B, 6A, 6B, 6C

The manner of using the fixture is to attach a transducer 30 to the attach points 21 and to attach a harness (straps, belts) to attach points 20. The fixture is then fixed in place on the upper back of the human body (FIGS. 6A, 6B, 6C) where left contact area 10 is in contact with left trapezius muscle group and the right contact area 11 is in contact with the right trapezius muscle group and the center section is spaced away from the spine 12. The fixture transmits the vibration from the transducer 30 to the left contact area 10 and the right contact area 11 which in turn transmits said vibration to the upper back of the human body.

### Advantages

From the description above, a number of advantages of some embodiments of my fixture become evident:

(a) The fixture can be ergonomically shaped to comfortably fit the human body and to allow any type of transducer to be attached to it. This allows any transducer regardless of its shape to be used in an ergonomic and comfortable manner.

(b) The shape of upper back of the human body varies much less than other parts of the body between individuals of various sizes, weights, heights, ages, and genders. In contrast, chests and abdomens vary greatly in shape between individuals of various sizes, weights, heights, ages, and genders. Because the fixture is designed to fit the upper back of the human body, the same fixture can comfortably be worn by a wide range of body types.

(c) The fixture allows a single vibration source to be applied symmetrically to both sides of the body.

(d) Because the center section 12 is spaced away from the spine, the fixture is only in contact with large muscle groups and is not in contact with any bones or high cartilage areas of the body. There are potential health concerns when vibration is applied directly to bones or cartilage and should be avoided.

(e) Because the center section 12 is spaced away from the body, the resulting air gap ventilates the attached transducer facilitating cooling from both the top and the bottom of said transducer. This is also more comfortable because an overly warm transducer does not directly contact the human body.

(f) The fixture serves as an attachment point when built into harnesses, clothing, backpacks, or other wearable objects.

(g) The fixture serves as a contact point when built into seats or other fixed objects.

(h) Because the fixture is placed on the upper back, it does not obstruct sitting in low back chairs, such as chairs and benches on municipal buses and subways.

### CONCLUSIONS, RAMIFICATIONS, AND SCOPE

Accordingly the reader will see that the rigid fixture ergonomically couples transducer created vibration to the human body facilitating visceral overall body sensations of audio or other content, in a small portable package. The fixture design is inherently unisex and allows various transducers to be used regardless of their shape. The fixture transmits vibration symmetrically to both sides of the body even when one transducer is used. The fixture is in contact with large muscle groups rather than the spine or other high cartilage areas. The fixture allows the transducer to be fully ventilated. The fixture serves as an attachment point for harnesses, straps, backpacks, or clothing. The fixture serves as contact point when incorporated into seats or other fixed objects. And the fixture can comfortably be worn when sitting in low back chairs.

Although the description above contains many specificities, these should not be construed as limiting the scope of the embodiments but as merely providing illustrations of some of several embodiments. For example, the fixture can have other shapes, such a rectangular or triangular etc. The center area could be shaped to accommodate various types of transducers, etc.

Thus the scope of the embodiments should be determined by the appended claims and their legal equivalents, rather than the examples given.

I claim:

1. A rigid fixture comprising a body of material having means for attaching or incorporating one or more transducers that is centered on the upper back of the human body where the left and right side of said fixture are in contact with said human body, and the center of said fixture is spaced away from said human body.

2. The rigid fixture of claim 1 where in said body of material is composed of plastic.

3. The rigid fixture of claim 1 where in said body of material is composed of composite material.

4. The rigid fixture of claim 1 where in said body of material is composed of wood.

5. The rigid fixture of claim 1 where in said body of material is composed of metal.

6. The rigid fixture of claim 1 where in said body of material is composed of ceramic.

7. The rigid fixture of claim 1 where the left side and right side of the fixture are in contact with the trapezius muscle groups.

8. The rigid fixture of claim 1 that includes means for attaching harnesses or other devices such that said fixture is incorporated into a wearable object.

9. The rigid fixture of claim 1 that includes means for incorporating said fixture into seats or other fixed objects that a human can be positioned against such that said fixture is in contact with the upper back of said human's body.

10. The rigid fixture of claim 1 that includes cushioning pads on the areas that are in contact with the human body.
